(19) United States
(12) Patent Application Publication
(10) Pub. No.: US 2001/0030176 A1
(43) Pub. Date: Oct. 18, 2001

(54) Switchable wavelength laser-based etched circuit board processing system

(76) Inventors: Yunlong Sun, Beaverton, OR (US); Edward J. Swenson, Portland, OR (US)

Correspondence Address: STOEL RIVES LLP, 900 SW FIFTH AVENUE, SUITE 2600, PORTLAND, OR, 97204, US

(21) Appl. No.: 09/730,894

(22) Filed: Dec. 5, 2000

Related U.S. Application Data
(60) Provisional application No. 60/253,120, filed on Dec. 7, 1999.

(51) Int. Cl. B23K 26/38; B23K 26/40

(52) U.S. Cl. 219/121.7; 219/121.71; 219/121.8

(57) ABSTRACT

A wavelength switchable laser (10) of this invention is based on a solid-state laser source (12) in which a fourth harmonic UV laser beam (26) is ordinarily used for processing, and a second harmonic “green” laser beam (28) is dumped and wasted. However, this invention uses the ordinarily wasted green laser beam for processing ECB (30) conductor layers (32, 36), which enhances processing throughout because of the higher power of the green energy than of the UV energy. A Pockel cell (16) effects laser beam polarization switching that causes either the green beam or the UV beam to be directed to the ECB for processing different materials. This invention requires only a single rail laser source and is, therefore, simple, cost effective, efficient, inherently aligned, and has high processing throughput.

### RELATED APPLICATION

This application claims priority from U.S. Provisional Patent Application No. 60/253,120, filed Dec. 7, 1999.

### FEDERALLY SPONSORED RESEARCH OR DEVELOPMENT

Not Applicable

### TECHNICAL FIELD

This invention relates to laser-based micro-machining and more particularly to a wavelength switchable laser for cutting via holes in conductor and dielectric layers of etched circuit boards.

### BACKGROUND OF THE INVENTION

There are previously known techniques of using different laser energy wavelengths for cutting conductor and dielectric layers of etched circuit boards (“ECBs”). For example, prior workers are using an infrared (“IR”) Nd:YAG laser and a CO₂ laser in a single ECB processing system. The YAG laser beam processes the copper layer with acceptable quality, and the CO₂ laser processes the dielectric layer with higher throughput.

In another example, U.S. Pat. No. 5,847,960 for MULTI-TOOL POSITIONING SYSTEM, which is assigned to the assignee of this application, describes a multi-rate, multi-tool positioner that cuts blind via holes in ECBs. Half of the tools are ultraviolet (“UV”) lasers, which readily cut conductor and dielectric layers, and the other half of the tools are IR lasers, which readily cut only dielectric layers. The UV lasers are controlled to cut an upper conductor layer and a portion of an underlying dielectric layer, and the IR lasers are controlled to cut the remaining dielectric layer without cutting through or damaging a second underlying conductor layer. The combined laser processing steps have a wide process window for cutting blind via holes in ECBs.

It is well known among ECB processing workers that UV laser wavelengths exhibit superior poly material processing qualities, such as a wide process window, small spot size, and clean holes. However, because UV lasers have limited UV power available, the processing throughput is limited in many applications. Moreover, using two lasers is unduly complex and costly and typically requires separate optics and tedious alignment.

Because of these problems, some prior worker have suggested using a single laser with a switchable wavelength. In particular, U.S. Pat. No. 5,361,268 for SWITCHABLE TWO-WAVELENGTH FREQUENCY-CONVERTING LASER SYSTEM AND POWER CONTROL THEREFORE, which is assigned to the assignee of this application, describes such a laser and its use in semiconductor via cutting. However, it is also quite inefficient and has insufficient UV output power for ECB processing.

What is needed, therefore, is a simple, efficient, cost-effective, and high throughput way of processing ECB via holes.

### SUMMARY OF THE INVENTION

An object of this invention is, therefore, to provide a switchable wavelength laser apparatus and a method suitable for use in ECB processing.

Another object of this invention is to provide a high throughput ECB via hole forming apparatus and method.

A wavelength switchable laser of this invention is based on a solid-state frequency conversion laser source of a type in which fourth harmonic UV laser energy is ordinarily used for processing, and second harmonic “green” laser energy is dumped and wasted. However, a preferred embodiment of this invention uses the ordinarily wasted green laser energy for processing ECB copper layers, which enhances processing throughout because of the higher power of the green energy than of the UV energy. This invention employs a Pockel cell-based wavelength selecting technique, so either the green or the UV laser energy is switched to the workpiece for processing different materials.

The copper via hole processing quality of green laser energy is believed to be superior to IR laser energy because of the higher absorption by copper of green energy. The superior dielectric processing quality of the UV energy is maintained. This invention requires only a single rail laser source and is, therefore, simple, cost effective, efficient, inherently aligned, and has high processing throughput.

Additional objects and advantages of this invention will be apparent from the following detailed description of a preferred embodiment thereof that proceeds with reference to the accompanying drawings.

### BRIEF DESCRIPTION OF THE DRAWINGS

FIG. 1 is a simplified block diagram of a switchable wavelength laser micro-machining system of this invention.

FIGS. 2A to 2C are cross-sectional pictorial views of conductor and dielectric layers of an ECB undergoing processing by the switchable wavelength laser of FIG. 1.

### DETAILED DESCRIPTION OF A PREFERRED EMBODIMENT

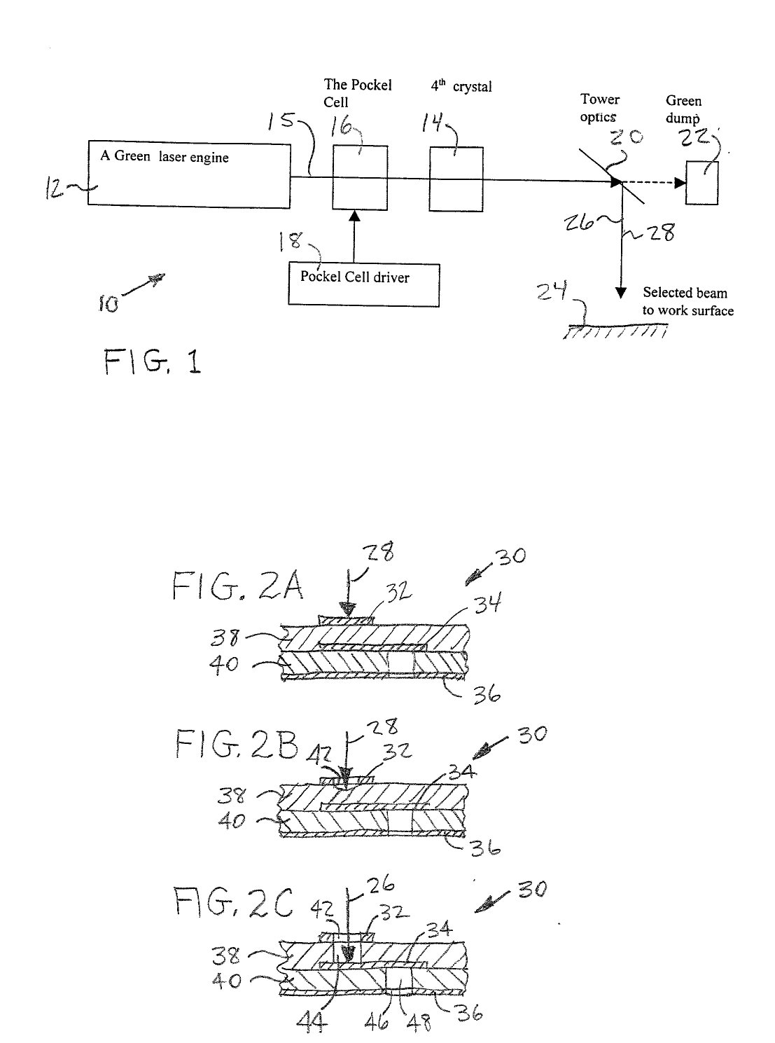

FIG. 1 shows a wavelength switchable laser 10 employing a laser source 12 that generates a second harmonic green wavelength of laser energy. A fourth harmonic generating non-linear crystal (“NLC”) 14 receives the green energy and converts some of it to UV energy.

Laser source 12 may be, for example, a 1,064 nanometer (“nm”) Nd:YAG or Nd:YVO₄ laser, or a 1,053 nm or 1,047 nm Nd:YLF laser. A Q-switch, second harmonic generating NLC, and resonator mirrors are all part of laser source 12. Laser source 12 is preferably a 1,064 nm Nd:YAG laser that generates a 532 nm green laser beam 15, although wavelengths less than about 355 nm are suitable. The NLCs of this invention may be formed from any of BBO, LBO, or CLBO crystals, or from any other suitable UV generating NLC material.

Wavelength selecting employs a Pockel Cell 16 inserted between laser source 12 and NLC 14. Pockel cell 16 is actuated by a Pockel cell driver 18. When Pockel cell driver 18 applies no drive voltage to Pockel cell 16, a portion of green laser beam 15 from laser source 12 is converted by NLC 14 to UV energy with the remainder being residual green energy. The UV energy polarization is rotated 90 degrees by NLC 14 relative to green laser beam 15. A tower mirror 20 is designed to reflect nearly 100% of the incoming laser beam energy having the same polarization as the UV energy. Consequently, the residual green energy propagates through tower mirror 20 into a green dump termination 22, while most of the UV energy is reflected to a workpiece 24, such as an ECB, for processing. The reflected UV energy is referred to hereafter as UV beam 26, which has a wavelength less than about 266 nanometers.

When Pockel cell driver 18 applies a predetermined voltage to Pockel cell 16, the polarization of green laser beam 15 is rotated by 90 degrees. This prevents NLC 14 from generating any UV energy because the green energy polarization is now unsuitable for frequency conversion. However, the green energy polarization is correct for reflection by tower mirror 20 and, therefore, substantially all of the green energy is reflected to workpiece 24 for processing. The reflected green energy is referred to hereafter as green beam 28, which has a wavelength less than about 532 nanometers.

A typical application of this invention is processing holes in workpiece 24, such as cutting via holes, in single or multi-layer, single-sided or double-sided ECBs. Multilayer ECBs are typically manufactured by registering, stacking together, laminating, and pressing multiple 0.05- to 0.08-millimeter (0.002- to 0.003-inch) thick circuit board layers. Each layer typically contains a different interconnection pad and conductor pattern, which after processing constitutes a complex electrical component mounting and interconnection assembly. The component and conductor density trend of ECBs is increasing together with that of integrated circuits. Therefore, the positioning accuracy and dimensional tolerances of holes in ECBs is increasing proportionally.

Processing via holes presents a difficult challenge for any hole processing tool because of the tight depth, diameter, and positioning tolerances involved. This is because via holes are typically processed through a first conductor layer (e.g., copper, aluminum, gold, nickel, silver, palladium, tin, and lead), through one or more dielectric layers (e.g., polyimide, FR-4 resin, benzocyclobutene, bismaleimide triazine, cyanate ester-based resin, ceramic), and up to, but not through a second conductor layer. The resulting via hole is typically plated with a conductive material to electrically connect the first and second conductor layers.

Some applications require cutting relatively large hole diameters of about 200 micrometers or less. Because UV laser beam energy typically has a beam diameter of only about 20 micrometers, the UV energy should follow a spiral or circular path to cut holes. However, the green energy has a larger beam diameter and will, therefore, cut relatively large diameter holes.

ECB thickness variations are readily accommodated by the ±0.13-millimeter (±0.005 inch) depth of field of wavelength switchable laser 10.

UV beam 26 and green beam 28 generated by switchable wavelength laser 10 are inherently aligned and suitable for use in processing ECBs formed from different materials, such as copper conductor layers and polyamide dielectric layers. Green beam 28 is preferred for processing the copper layers, and UV beam 26 is preferred for processing the dielectric layers formed from polyamide or other poly materials. In general, this invention provides more green energy than UV energy. By using green beam 28 for processing the copper, higher processing throughput is realized, and by using UV beam 26 for processing the dielectric material, superior processing quality is maintained.

FIGS. 2A to 2C show an exemplary multi-layer ECB 30 having respective first, second, and third conductor layers 32, 34, and 36 separated by respective first and second dielectric layers 38 and 40. In this typical example, first and second conductor layers 32 and 34 were etched to predetermined patterns prior to the laminating together of first and second dielectric layers 38 and 40. In this example, third conductor layer 36 is a conductive planar “ground plane” layer. ECB 30 is preferably processed as follows by switchable wavelength laser 10, which is initially switched to generate green beam 28.

FIG. 2A shows green beam 28 landing on first conductor layer 32.

FIG. 2B shows green beam 28 processing a hole 42 through first conductor layer 32 and landing on and partially processing first dielectric layer 38. At this point wavelength switchable laser 10 is switched from generating green beam 28 to generating UV beam 26.

FIG. 2C shows UV beam 26 processing a hole 44 through first dielectric layer 38 and landing on second conductor layer 34. As described above, UV beam 26 preferably follows a spiral or circular path to process hole 44 in first dielectric layer 38. Because of the relatively low power of UV beam 26 and the reflectivity of the conductor layers, hole 44 self-terminates at second conductor layer 34, resulting in a wide process window.

FIG. 2C further shows holes 46 and 48 extending respectively through third conductor layer 36 and second dielectric layer 40. Holes 46 and 48 are preferably processed in the same manner as holes 42 and 44, but with ECB 30 turned over so that green beam 28 and UV beam 26 respectively process third conductor layer 36 and second dielectric layer 40.

Skilled workers will recognize that portions of this invention may be implemented differently from the implementations described above for a preferred embodiment. For example, different lasers, harmonics, wavelengths, and power levels, may be employed to process a variety of material combinations in ECBs and other micro-machining applications. Laser source 12 typically requires an optical pump source for the lasing medium (arc lamp, laser diodes, etc.), a cooling system for the optical pump source, and control electronics. A laser diode pump source is preferred. Frequency doubling the fundamental frequency of IR laser source 12 generates the second harmonic green energy and then frequency doubling again (quadrupling) generates the fourth harmonic UV energy. Alternatively, frequency mixing the IR and the green energy (tripling) generates third harmonic UV energy.

It will be obvious to those having skill in the art that many other changes may be made to the details of the above-described embodiment of this invention without departing from the underlying principles thereof. Accordingly, it will be appreciated that this invention is also applicable to laser-based machining applications other than those found in etched circuit board manufacturing. The scope of this invention should, therefore, be determined only by the following claims.

We claim:

1. An apparatus for processing holes in an etched circuit board (“ECB”) including at least first and second conductor layers separated by a dielectric layer, comprising:
a single rail laser system that selectably generates a green wavelength beam and a UV wavelength beam, the green wavelength beam processing a hole through the first conductor layer and a portion of the dielectric layer, the UV wavelength beam completing processing of the hole through a remaining portion of the dielectric layer, and the UV wavelength beam terminating processing on the second conductor layer.

2. The apparatus of claim 1 in which the single rail laser system includes an infrared (“IR”) laser and a frequency doubling non-linear crystal to generate the green wavelength beam.

3. The apparatus of claim 2 in which the non-linear crystal is formed from any of a BBO, a LBO, or a CLBO crystal.

4. The apparatus of claim 1 in which the single rail laser system further includes:
a polarization switching cell for switching the green wavelength beam between first and second polarization states;
a harmonic generating non-linear crystal, which when receiving the green wavelength beam in the first polarization state, generates the UV wavelength beam in the second polarization state and propagates a residual green wavelength beam in the first polarization state, and which when receiving the green wavelength beam in the second polarization state, propagates the green wavelength beam in the second polarization state; and
a polarization selective mirror that reflects beams in the second polarization state such that the UV and green wavelength beams are reflected to the ECB, and the residual green wavelength beam is propagated through the mirror away from the ECB.

5. The apparatus of claim 4 in which the non-linear crystal is formed from any of a BBO, a LBO, or a CLBO crystal.

6. The apparatus of claim 1 in which the single rail laser system includes a Nd:YAG, Nd:YVO₄, or a Nd:YLF laser.

7. The apparatus of claim 1 in which the green wavelength beam has a wavelength less than about 532 nanometers.

8. The apparatus of claim 1 in which the first and second conductor layers are formed from at least one of copper, aluminum, gold, nickel, silver, palladium, tin, and lead.

9. The apparatus of claim 1 in which the dielectric layer is formed from at least one of polyimide, FR-4 resin, benzocyclobutene, bismaleimide triazine, cyanate ester-based resin, and ceramic.

10. A method for processing holes in an etched circuit board (“ECB”) including at least first and second conductor layers separated by a dielectric layer, comprising:
providing a single rail laser system that selectably generates a green wavelength beam and a UV wavelength beam;
switching the single rail laser system to generate the green wavelength beam;
processing with the green wavelength beam a hole through the first conductor layer and in a portion of the dielectric layer;
switching the single rail laser system to generate the UV wavelength beam; and
processing with the UV wavelength beam the hole through a remaining portion of the dielectric layer.

11. The method of claim 10 in which providing the single rail laser system further includes:
providing a polarization switching cell for switching the green wavelength beam between first and second polarization states;
providing a harmonic generating non-linear crystal, which when receiving the green wavelength beam in the first polarization state, generates the UV wavelength beam in the second polarization state and propagates a residual green wavelength beam in the first polarization state, and which when receiving the green wavelength beam in the second polarization state, propagates the green wavelength beam in the second polarization state; and
providing a polarization selective mirror that reflects beams in the second polarization state such that the UV and green wavelength beams are reflected to the ECB, and the residual green wavelength beam is propagated through the mirror away from the ECB.

12. The method of claim 10 further including deflecting the UV wavelength beam along a spiral or a circular path to process the hole in the remaining portion of the dielectric layer.

13. The method of claim 10 further including terminating processing of the hole on the second conductor layer.

14. The method of claim 13 in which the terminating processing step is a self-terminating step caused by an insufficient power level of the UV wavelength beam for processing the second conductor layer.

15. The method of claim 13 in which the terminating processing step is a self-terminating step caused by a reflection of the UV wavelength beam off the second conductor layer.

16. The method of claim 13 in which the terminating processing step is a self-terminating step caused by at least one of an insufficient power level of the UV wavelength beam for processing the second conductor layer and a reflection of the UV wavelength beam off the second conductor layer.
